(19) United States
(12) Patent Application Publication
(10) Pub. No.: US 2026/0171508 A1
(43) Pub. Date: Jun. 18, 2026

(54) METHOD OF PRODUCING ELECTRODE ASSEMBLY AND METHOD OF PRODUCING NON-AQUEOUS ELECTROLYTE SECONDARY BATTERY

(71) Applicants: TOYOTA JIDOSHA KABUSHIKI KAISHA, Toyota-shi (JP); TOYOTA BATTERY CO., LTD., Kosai-shi (JP); PRIME PLANET ENERGY & SOLUTIONS, INC., Tokyo (JP)

(72) Inventors: Juni YASOSHIMA, Nagoya-shi (JP); Kentaro SUZUKI, Ann Arbor, MI (US); Tetsuya OKADO, Kako-gun (JP); Nobuaki KOIWA, Gamagori-shi (JP)

(73) Assignees: TOYOTA JIDOSHA KABUSHIKI KAISHA, Tokyota-shi (JP); TOYOTA BATTERY CO., LTD., Kosai-shi (JP); PRIME PLANET ENERGY & SOLUTIONS, INC., Tokyo (JP)

(21) Appl. No.: 19/414,488

(22) Filed: Dec. 10, 2025

(30) Foreign Application Priority Data
Dec. 13, 2024 (JP) 2024-218909

(51) Int. Cl. H01M 10/0587

(52) U.S. Cl. CPC H01M 10/0587

(57) ABSTRACT

A method of producing an electrode assembly comprises: a stacking step to stack a positive electrode and a negative electrode with a separator interposed therebetween to form a stack; a winding step to wind the stack to form a wound body; and a pressing step to press the wound body to form a wound electrode assembly having a flat form. A press load in the pressing step is less than 140 kN. A thickness of the separator in the wound electrode assembly is from 16 μm to 20 μm. When the press load is denoted as A (kN), the thickness of the separator in the wound electrode assembly is denoted as B (μm), and a thickness of the negative electrode in the wound electrode assembly is denoted as C (μm), [A/(B/C)] is from 190 kN to 473 kN.

### CROSS REFERENCE TO RELATED APPLICATIONS

This nonprovisional application is based on Japanese Patent Application No. 2024-218909 filed on Dec. 13, 2024, with the Japan Patent Office, the entire contents of which are hereby incorporated by reference.

### BACKGROUND

### Field

The present disclosure relates to a method of producing an electrode assembly and a method of producing a non-aqueous electrolyte secondary battery.

### Description of the Background Art

Japanese Patent Laying-Open No. 2023-041494 discloses a non-aqueous electrolyte solution secondary battery which is produced by performing pressing so as to make the thickness of the electrode assembly and the air permeability of the separator fall within certain ranges, to thereby prevent non-uniformity in the resistance of the electrode assembly and accordingly inhibit deposition of metal lithium (which can occur due to non-uniform current density).

### SUMMARY

A wound electrode assembly is formed by spirally winding a belt-shaped electrode plate and a belt-shaped separator together. After the winding, the outer shape of the wound electrode assembly is tubular. For use in a prismatic battery and/or the like, for example, the tubular wound electrode assembly is pressed into a flat form suitable for the outer shape of the battery.

In a flat-form wound electrode assembly, the temperature can rise due to overcharging and/or lithium (Li) can become deposited. Moreover, resistance against overcharging and resistance against Li deposition are in a trade-off relationship, and therefore, from the viewpoint of enhancing both, there is room for improvement in the method of producing an electrode assembly.

An object of the present disclosure is to provide a method of producing an electrode assembly that can achieve enhanced resistance against overcharging as well as enhanced resistance against Li deposition.

Hereinafter, the technical configuration and effects of the present disclosure will be described. It should be noted that the action mechanism according to the present disclosure includes presumption. The scope of claims should not be limited by whether or not the action mechanism is correct.
[1] A method of producing an electrode assembly, the method comprising:
a stacking step to stack a positive electrode and a negative electrode with a separator interposed therebetween to form a stack;
a winding step to wind the stack to form a wound body; and
a pressing step to press the wound body to form a wound electrode assembly having a flat form, wherein
a press load in the pressing step is less than 140 kN,
a thickness of the separator in the wound electrode assembly is from 16 μm to 20 μm, and
when the press load is denoted as A (kN), the thickness of the separator in the wound electrode assembly is denoted as B (μm), and a thickness of the negative electrode in the wound electrode assembly is denoted as C (μm), [A/(B/C)] is from 190 kN to 473 kN.

It is conceivable that when the distance between a separator and a negative electrode active material layer is increased in an electrode assembly, overcharging tends not to occur and thereby resistance against overcharging can be enhanced. It is also conceivable that when the distance between a separator and a negative electrode active material layer is reduced, the distance Li ions travel is reduced and thereby resistance against Li deposition can be enhanced. With the configuration of [1] where the press load, the thickness of the separator in the wound electrode assembly after pressing, and the thickness of the negative electrode in the wound electrode assembly after pressing fall within certain numerical ranges, it is expected that an electrode assembly that can achieve enhanced resistance against overcharging as well as enhanced resistance against Li deposition can be provided.

For example, with the configuration of [1], the negative electrode active material may be pushed into pores in the separator. With this structure, it is conceivable that the distance Li ions travel between the separator and the negative electrode active material layer is reduced and thereby resistance against Li deposition can be enhanced.
[2] The method of producing an electrode assembly according to [1], wherein the press load is more than 50 kN.

With the press load exceeding 50 kN, springback tends to be reduced. As a result, in a method of producing a non-aqueous electrolyte secondary battery comprising the electrode assembly and an electrolyte solution, workability for placing the electrode assembly into an exterior package is expected to be enhanced. Hence, with the configuration of [2], in addition to enhanced resistance against overcharging and enhanced resistance against Li deposition, enhanced workability for placing the electrode assembly into an exterior package is also expected to be achieved.
[3] The method of producing an electrode assembly according to [1] or [2], wherein
the press load is not less than 60 kN and less than 130 kN, and
[A/(B/C)] is from 342 kN to 473 kN.
[4] The method of producing an electrode assembly according to any one of [1] to [3], wherein the thickness of the negative electrode in the wound electrode assembly is from 76 μm to 84 μm.
[5] A method of producing a non-aqueous electrolyte secondary battery, the method comprising:
producing the electrode assembly by the method of producing an electrode assembly according to any one of [1] to [4]; and
producing a non-aqueous electrolyte secondary battery including the electrode assembly and an electrolyte solution.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an example schematic flowchart illustrating a method of producing an electrode assembly according to an embodiment of the present disclosure.

FIG. 2 is a schematic view illustrating an example configuration of an electrode assembly according to an embodiment of the present disclosure.

FIG. 3 is a table showing evaluation results in Production Example of the present disclosure.

FIG. 4 is a graph showing the relationship between the press load, the thickness of the separator in the wound electrode assembly, and the thickness of the negative electrode in the wound electrode assembly in Production Example of the present disclosure.

### DESCRIPTION OF THE PREFERRED EMBODIMENTS

In the following, an embodiment of the present disclosure (which may be simply called “the present embodiment” hereinafter) and an example of the present disclosure (which may be simply called “the present example” hereinafter) will be described. It should be noted that neither the present embodiment nor the present example limits the technical scope of the present disclosure.

### Method of Producing Electrode Assembly

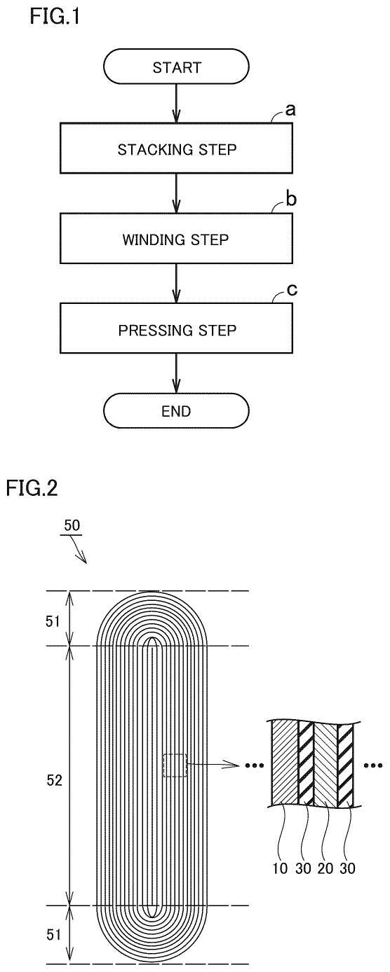

FIG. 1 is an example schematic flowchart illustrating a method of producing an electrode assembly according to the present embodiment. The method of producing an electrode assembly according to the present embodiment includes at least (a) a stacking step, (b) a winding step, and (c) a pressing step. FIG. 2 is a schematic view illustrating an example configuration of an electrode assembly according to the present embodiment. A wound electrode assembly 50 includes a curved portion 51 and a flat portion 52. At curved portion 51, each of a positive electrode 10, a negative electrode 20, and a separator 30 has a curved surface. At flat portion 52, each of positive electrode 10, negative electrode 20, and separator 30 has a flat surface.
(a) Stacking Step

In the stacking step, positive electrode 10 and negative electrode 20 are stacked together with separator 30 interposed therebetween, to form a stack. Each of positive electrode 10, negative electrode 20, and separator 30 may have a belt-like planar shape. For example, the stack may be formed by stacking positive electrode 10, separator 30, negative electrode 20, and separator 30 in this order.
(b) Winding Step

In the winding step, the stack is wound to form a wound body. The belt-shaped stack formed in the stacking step is wound spirally around the axis of winding, to form the wound body. The wound body may be tubular, for example.
(c) Pressing Step

In the pressing step, the wound body is pressed to form a wound electrode assembly 50 having a flat form. The tubular wound body formed in the winding step is pressed in a radial direction with a certain press load, to form the flat-form wound electrode assembly 50. The pressing step may be carried out by applying mechanical pressure with the use of a press machine, a press member, and/or the like, for example. Wound electrode assembly 50 includes positive electrode 10, negative electrode 20, and separator 30.

Positive electrode 10 may be configured to include a positive electrode current collector and a positive electrode active material layer. The positive electrode current collector may be an aluminum (Al) foil sheet, an Al alloy foil sheet, a copper (Cu) foil sheet, and/or a Cu alloy foil sheet, for example. The positive electrode current collector may have a thickness from 10 μm to 30 μm, for example. The positive electrode active material layer may be formed on the surface of the positive electrode current collector. The positive electrode active material layer may have a thickness from 10 μm to 200 μm, for example. The positive electrode active material layer may have a density from 1.5 g/cm³ to 4.0 g/cm³, for example. It should be noted that the density of the positive electrode active material layer according to the present embodiment refers to the apparent density.

The positive electrode active material layer includes a positive electrode active material. As the positive electrode active material, lithium cobalt oxide (LiCoO₂), lithium nickel oxide (LiNiO₂), and/or lithium manganese oxide (LiMn₂O₄) can be used, for example. A material prepared by mixing LiCoO₂, LiMn₂O₄, and LiNiO₂ in a freely-selected proportion may be used. In addition to the positive electrode active material, the positive electrode active material layer may further include a conductive material, a binder, and/or the like, for example. The conductive material may include a carbon material such as acetylene black (AB), Ketjenblack, graphite, and/or the like, for example. The binder may include polyvinylidene difluoride (PVdF), polytetrafluoroethylene (PTFE), polyacrylic acid (PAA), and/or styrene-butadiene rubber (SBR), for example. The amount of each of the conductive material and the binder to be used relative to 100 parts by mass of the positive electrode active material may be from 0.1 parts by mass to 10 parts by mass, for example.

Negative electrode 20 may be configured to include a negative electrode current collector and a negative electrode active material layer. The negative electrode current collector may be a Cu foil sheet, a Cu alloy foil sheet, a nickel (Ni) foil sheet, and/or a Ni alloy foil sheet, for example. The negative electrode current collector may have a thickness from 5 μm to 30 μm, for example. The negative electrode active material layer may be formed on the surface of the negative electrode current collector. The negative electrode active material layer may have a thickness from 10 μm to 200 μm, for example. The negative electrode active material layer may have a density from 0.8 g/cm³ to 1.8 g/cm³, for example. It should be noted that the density of the negative electrode active material layer according to the present embodiment refers to the apparent density.

The negative electrode active material layer includes a negative electrode active material. The negative electrode active material may include graphite, soft carbon, hard carbon, silicon, silicon oxide, tin, and/or tin oxide, for example. In addition to the negative electrode active material, the negative electrode active material layer may further include a conductive material, a binder, a thickener, and/or the like, for example. The conductive material may include a carbon material such as acetylene black (AB), Ketjenblack, graphite, and/or the like, for example. The binder may include polyvinylidene difluoride (PVdF), polytetrafluoroethylene (PTFE), polyacrylic acid (PAA), and/or styrene-butadiene rubber (SBR), for example. The thickener may include carboxymethylcellulose (CMC), for example. The amount of each of the conductive material, the binder, and the thickener to be used relative to 100 parts by mass of the negative electrode active material may be from 0.1 parts by mass to 10 parts by mass, for example.

Separator 30 is an electrically insulating porous film. Separator 30 is interposed between positive electrode 10 and negative electrode 20. Separator 30 may be made of polyolefin, for example. Separator 30 may have a monolayer structure, for example. Separator 30 may be made of a polyethylene (PE) layer, for example. Separator 30 may have a multilayer structure, for example. Separator 30 may have a three-layer structure, for example. Separator 30 may include a polypropylene (PP) layer, a PE layer, and a PP layer, for example. The PP layer, the PE layer, and the PP layer may be stacked in this order. On the surface of separator 30, a heat-resistant layer may be formed, for example. The heat-resistant layer may include a heat-resistant material such as boehmite, alumina, and/or the like, for example.

Separator 30 may have an air permeability from 100 s/100 mL to 600 s/100 mL, for example. It should be noted that the air permeability refers to the “air resistance” defined by “JIS P8117:2009 Paper and board-Determination of air permeance and air resistance (medium range)-Gurley method”. The air permeability (air resistance) refers to the time (per unit area and unit pressure) that is required for passage of a specified volume of air. The air permeability is measured by a method using an Oken-type tester. The air permeability is expressed as time (seconds) per 100 mL.

Separator 30 may have a porosity from 30% to 60%, for example.

The press load may be 40 kN or more, or may be more than 50 kN, or may be 60 kN or more, or may be 90 kN or more. The press load may be less than 140 kN, or less than 130 kN.

The press temperature may be room temperature, for example. The press temperature may be from 15° C. to 35° C., or may be 20° C., or may be 25° C., for example.

The thickness of positive electrode 10 in wound electrode assembly 50 after the pressing step may be from 10 μm to 200 μm, or may be from 20 μm to 100 μm.

The thickness of negative electrode 20 in wound electrode assembly 50 after the pressing step may be from 10 μm to 200 μm, or may be from 20 μm to 100 μm, or may be from 70 μm to 90 μm, or may be from 75 μm to 85 μm, or may be from 76 μm to 84 μm.

The thickness of separator 30 in wound electrode assembly 50 after the pressing step is from 16 μm to 20 μm.

Each of the thickness of positive electrode 10, the thickness of negative electrode 20, and the thickness of separator 30 is measured with a constant-pressure thickness-measuring instrument (a thickness gauge), for example. Each of the thickness of positive electrode 10, the thickness of negative electrode 20, and the thickness of separator 30 may be the thickness measured at flat portion 52 of wound electrode assembly 50. Each of the thickness of positive electrode 10, the thickness of negative electrode 20, and the thickness of separator 30 is measured at three or more different positions of flat portion 52 of wound electrode assembly 50, for example. The arithmetic mean of the measurements at these three or more positions is regarded as the thickness. Regarding each of positive electrode 10, negative electrode 20, and separator 30, the thickness at curved portion 51 and the thickness at flat portion 52 may be different from each other.

When the press load in the pressing step is denoted as A (kN), the thickness of separator 30 in wound electrode assembly 50 is denoted as B (μm), and the thickness of negative electrode 20 in wound electrode assembly 50 is denoted as C (μm), [A/(B/C)] is from 190 kN to 473 kN, and it may be more than 283 kN and not more than 473 kN, or may be from 342 kN to 473 kN.

By the steps described above, the electrode assembly according to the present embodiment is produced.

### Method of Producing Non-Aqueous Electrolyte Secondary Battery

A method of producing a non-aqueous electrolyte secondary battery (hereinafter, “a non-aqueous electrolyte secondary battery” may be simply called “a battery”) according to the present embodiment includes producing a non-aqueous electrolyte secondary battery including an electrode assembly and an electrolyte solution. The method of producing the electrode assembly is as described above.

For example, the method of producing a non-aqueous electrolyte secondary battery according to the present embodiment may further include, in addition to the above-described method of producing an electrode assembly, a placement step to place flat-form wound electrode assembly 50 into an exterior package as well as an injection step to inject an electrolyte solution into the exterior package.

In the placement step, flat-form wound electrode assembly 50 is placed into an exterior package. The exterior package has any configuration. The exterior package may be prismatic or cylindrical, for example. The exterior package may be a container made of metal, or may be a pouch made of a metal foil laminated film, for example.

In the injection step, an electrolyte solution is injected into the exterior package in which wound electrode assembly 50 is placed. The electrolyte solution includes a non-aqueous solvent and a supporting electrolyte.

The non-aqueous solvent may be ethylene carbonate (EC), propylene carbonate (PC), butylene carbonate (BC), dimethyl carbonate (DMC), ethyl methyl carbonate (EMC), diethyl carbonate (DEC), and/or the like, for example. One type of the non-aqueous solvents may be used alone, or two or more types of the non-aqueous solvents may be used in combination.

The supporting electrolyte is dissolved in the non-aqueous solvent. The supporting electrolyte may be a lithium salt (such as LiPF₆, LiBF₄, LiClO₄, LiAsF₆, and LiN(FSO₂)₂), for example. One type of the supporting electrolytes may be used alone, or two or more types of the supporting electrolytes may be used in combination. The supporting electrolyte may have a molarity from 0.5 mol/L to 2 mol/L, for example.

In addition to the non-aqueous solvent and the supporting electrolyte, the electrolyte solution may further include any additive. The additive may include vinylene carbonate (VC) and/or vinylethylene carbonate (VEC), for example. The amount of the additive to be used relative to 100 parts by mass of the electrolyte solution may be from 0.01 parts by mass to 5 parts by mass. After injection of the electrolyte solution, the exterior package is sealed, and thereby a non-aqueous electrolyte secondary battery is produced.

The resistance of the non-aqueous electrolyte secondary battery against overcharging can be evaluated by checking changes in temperature that occur due to heat produced from the battery at the time of overcharging of the battery, for example. When the temperature changes due to heat production are small, it can be regarded that the non-aqueous electrolyte secondary battery has enhanced resistance against overcharging.

The resistance of the non-aqueous electrolyte secondary battery against Li deposition can be evaluated by checking whether Li is deposited during repeated charge and discharge, for example. When no Li deposition is observed, it can be regarded that the non-aqueous electrolyte secondary battery has enhanced resistance against Li deposition.

### EXAMPLES

In the following, the present disclosure will be described in further detail by way of Production Example, but the present disclosure is not limited to Production Example.

### Production Example

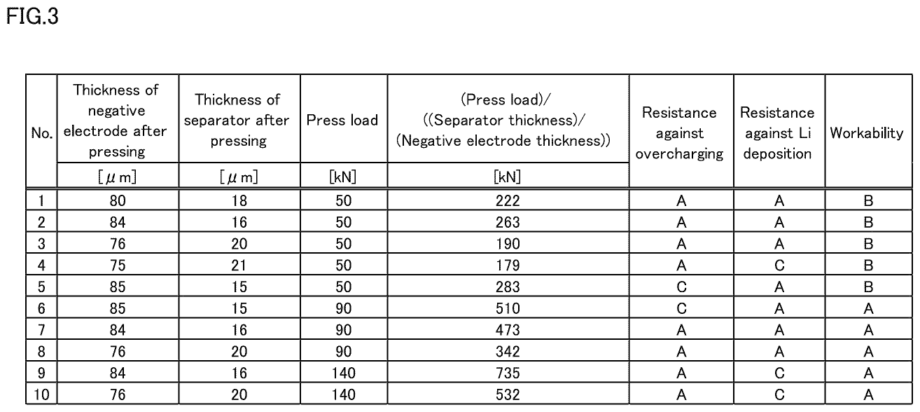

For the purpose of producing a flat-form wound electrode assembly, a positive electrode, a negative electrode, and a separator were prepared. The positive electrode and the negative electrode were stacked with the separator interposed therebetween, to form a stack. Then, the stack was wound spirally around the axis of winding, to form a tubular wound body. Then, the resultant was pressed at room temperature with the press load specified in FIG. 3, and thereby the tubular wound body was shaped into a flat form. Thus, flat-form wound electrode assemblies of No. 1 to No. 10 were produced. At the flat portion of each wound electrode assembly, the thickness of the negative electrode and the thickness of the separator were measured.

For the purpose of producing an evaluation-purpose battery, an electrolyte solution as well as a pouch made of laminated film as an exterior package were prepared. The flat-form wound electrode assembly was placed into the pouch, and the electrolyte solution was injected. After injection of the electrolyte solution, the pouch was sealed and thereby an evaluation-purpose battery was produced.

The evaluation-purpose battery was subjected to evaluation of resistance against overcharging and resistance against Li deposition. Moreover, at the time of producing the evaluation-purpose battery, workability for placing the wound electrode assembly into the exterior package was also evaluated. Results are given in FIG. 3. In the column “Resistance against overcharging” in FIG. 3, “A” represents that the resistance against overcharging was desirable for a product, and “C” represents that the resistance against overcharging was undesirable for a product. In the column “Resistance against Li deposition” in FIG. 3, “A” represents that the resistance against Li deposition was desirable for a product, and “C” represents that the resistance against Li deposition was undesirable for a product. In the column “Workability” in FIG. 3, “A” represents that placement into the exterior package was very easy, and “B” represents that placement into the exterior package was easy.

In No. 1 to No. 3, No. 7, and No. 8, resistance against overcharging and resistance against Li deposition were both good. No. 4 exhibited poor resistance against Li deposition, probably because the separator was thick and the resistance was high. No. 5 and No. 6 exhibited poor resistance against overcharging, probably because the separator was thin. No. 9 and No. 10 exhibited poor resistance against Li deposition, probably because the press load was great and thereby clogging of the separator occurred.

No. 6 to No. 10 exhibited very good workability for placement into the exterior package. In particular, No. 7 and No. 8 were excellent in all of the resistance against overcharging, the resistance against Li deposition, and the workability. On the other hand, in No. 1 to No. 5, the press load was 50 kN and therefore springback occurred to a great extent, and, as a result, workability for placement into the exterior package was slightly inferior to No. 6 to No. 10.

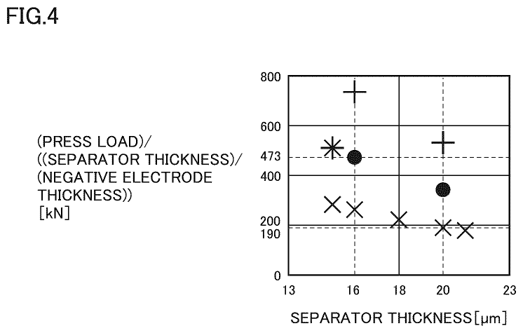

As for the electrode assemblies of No. 1 to No. 10, the relationship between the press load, the thickness of the separator in the wound electrode assembly, and the thickness of the negative electrode in the wound electrode assembly was plotted, and the graph is given in FIG. 4. When the plot is within a region surrounded by the four dotted lines in FIG. 4, enhanced resistance against overcharging and enhanced resistance against Li deposition may be exhibited. In other words, on a two-dimensional X-Y plane with the X axis representing the thickness of the separator and the Y axis representing [(press load)/(separator thickness)/(negative electrode thickness)], when 16≤X≤20 and 190≤Y≤473 are satisfied, enhanced resistance against overcharging and enhanced resistance against Li deposition may be exhibited. In No. 1 to No. 3, No. 7, and No. 8, the plots are within the above-mentioned region. Moreover, when the plot is within the above-mentioned region and the press load is more than 50 kN, not only the resistance against overcharging and the resistance against Li deposition but also the workability for placing the electrode assembly into the exterior package may be enhanced. In No. 7 and No. 8, the plots are within the above-mentioned region and the press load is more than 50 kN. In No. 7 and No. 8, on the two-dimensional X-Y plane, the plots are within the region that satisfies 16≤X≤20 and 283<Y≤473.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A method of producing an electrode assembly, the method comprising:
a stacking step to stack a positive electrode and a negative electrode with a separator interposed therebetween to form a stack;
a winding step to wind the stack to form a wound body; and
a pressing step to press the wound body to form a wound electrode assembly having a flat form, wherein a press load in the pressing step is less than 140 kN,
a thickness of the separator in the wound electrode assembly is from 16 μm to 20 μm, and
when the press load is denoted as A (kN), the thickness of the separator in the wound electrode assembly is denoted as B (μm), and a thickness of the negative electrode in the wound electrode assembly is denoted as C (μm), [A/(B/C)] is from 190 kN to 473 kN.

2. The method of producing an electrode assembly according to claim 1, wherein the press load is more than 50 kN.

3. The method of producing an electrode assembly according to claim 2, wherein
the press load is not less than 60 kN and less than 130 kN, and
[A/(B/C)] is from 342 kN to 473 kN.

4. The method of producing an electrode assembly according to claim 3, wherein the thickness of the negative electrode in the wound electrode assembly is from 76 μm to 84 μm.

5. A method of producing a non-aqueous electrolyte secondary battery, the method comprising:
producing the electrode assembly by the method of producing an electrode assembly according to claim 1; and
producing a non-aqueous electrolyte secondary battery including the electrode assembly and an electrolyte solution.
